(19) United States
(12) Patent Application Publication
(10) Pub. No.: US 2020/0132044 A1
(43) Pub. Date: Apr. 30, 2020

(54) WIND TURBINE

(71) Applicant: Vertogen Ltd., Lancashire (GB)

(72) Inventors: Michael Chung, Bury (GB); David Dunphy, Warrington (GB)

(21) Appl. No.: 16/628,643

(22) PCT Filed: Jun. 29, 2018
(86) PCT No.: PCT/GB2018/051839

§ 371 Date: Jan. 3, 2020

(30) Foreign Application Priority Data
Jul. 4, 2017 (GB) 1710753.3

(51) Int. Cl. F03D 3/06; F03D 7/06

(52) U.S. Cl. CPC F03D 3/067; F03D 7/06

(57) ABSTRACT

A variable-pitch vertical axis wind turbine comprises a hub supported for rotation about a central axis and a blade pivotally mounted to the hub so as to permit relative rotation between the blade and the hub. The blade and the hub define a pitch angle therebetween. The wind turbine comprises a mechanism configured to produce reciprocating motion during rotation of the hub about the central axis. The wind turbine comprises a linkage configured to transfer the reciprocating motion produced by the mechanism to the blade so as to vary the pitch angle.

The present invention relates to wind turbines, and in particular to a variable-pitch vertical axis wind turbine.

Wind turbines are devices which convert kinetic energy present in wind to useful work such as mechanical or electrical power. Wind turbines typically comprise a rotor which can be blown by the wind to produce rotational movement which is then used to power an electricity generator. The diameter of the rotor may vary from a few centimetres in low-power applications (for example in survival or camping equipment) up to 150 metres or more in high-power applications (for example in mains power generation). Wind turbine designs can be generally categorised as one of two types, namely: horizontal axis wind turbines (HAWTs) and vertical axis wind turbines (VAWTs). HAWTs are characterised by a rotor supported for rotation about a horizontal axis. Typically, a HAWT rotor comprises three blades having aerofoil-shaped cross-sections which are supported at a central hub. As wind approaches the rotor, the aerofoil-shaped blades deflect the wind so as to cause the blades to rotate with the hub about the horizontal axis.

VAWTs are a less common configuration of wind turbine than HAWTs and comprise a rotor supported for rotation about a vertical axis. Typically, the rotors of such VAWTs comprise one or more blades supported by a hub. A generator, or other suitable rotational power converter, is connected to the hub to convert rotational energy of the hub into useful work and/or electrical power.

In contrast to HAWTs, common to all VAWTs is that, as the blades rotate about the vertical axis, half of the rotation will be in the same direction as the wind and half of the rotation will be in the opposite direction as the wind. As such, in order to get the blades to rotate, the amount of kinetic energy absorbed from the wind by the half of the rotor rotating with the wind must be great enough to permit the blades to overcome any drag associated with moving the half of the rotor into the direction of the oncoming wind.

Savonius type VAWTs are able to achieve such rotation by having generally semi-circular concave blades configured to exhibit a relatively large amount of drag as wind travels into their concave sides (such that the blade effectively scoops the wind) and a relatively low amount of drag on their convex sides. Darrieus type VAWTs are another design of VAWT which are able to achieve such rotation by the use of blades having an aerofoil shape which generates lift so as to cause the hub to rotate about the vertical axis.

Because Darrieus type VAWTs are driven by lift rather than drag, at low wind speeds the blades are often unable to produce sufficient lift to cause rotation of the rotor and therefore it is common for such wind turbines to comprise an electric motor configured to initiate rotation in low wind speeds. Furthermore, as wind speed increases the rotational velocity of the rotor also increases, resulting in the application of high centrifugal forces to the components of the wind turbine. In such high wind-conditions, it is common for Darrieus type wind turbines to be limited by a mechanical brake or simply shut-down. As such, the range of wind speed within which Darrieus type wind turbines can operate is relatively narrow.

There exists a need to obviate or mitigate one or more problems of the prior art, whether identified herein or elsewhere.

According to a first aspect of the present invention there is provided a variable-pitch vertical axis wind turbine comprising:
a hub supported for rotation about a central axis;
a blade pivotally mounted to the hub so as to permit relative rotation between the blade and the hub, the blade and the hub defining a pitch angle therebetween;
a mechanism configured to produce reciprocating motion during rotation of the hub about the central axis; and
a linkage configured to transfer the reciprocating motion produced by the mechanism to the blade so as to vary the pitch angle.

Aerodynamic forces such as lift and drag are generated by the blade as it is blown by the wind. The lift and drag forces produce a net resultant force acting on the blade which causes it to rotate about the central axis along a circular path defined by the rotation of the hub. The blade produces maximum lift when it is disposed at its furthest upstream and furthest downstream locations relative to the direction of the oncoming wind. By varying the pitch angle as the blade rotates about the central axis, more lift can be produced during the upstream and downstream parts of the circular path, whilst simultaneously minimising the amount of drag produced when the blade is moving directly into or away from the oncoming wind. As such, the efficiency of the wind turbine is increased.

If the amount of lift produced by the blade is not large enough, the blade will not rotate about the central axis and the wind turbine will not produce any power. The amount of lift produced by the blade is determined by the angle of attack of the blade relative to the oncoming air (i.e. the direction of air flow from the perspective of the blade). By increasing the angle of attack, for example by increasing or decreasing the pitch angle, more lift can be produced by the blade and therefore the wind turbine produces more power for a given wind speed and, in addition, is able to operate over an increased range of wind speeds. As such, the wind turbine is able to begin rotating and producing power at relatively low wind speeds, and therefore does not require a starter motor to initiate rotation.

It will be appreciated that by pitch angle it is meant the relative angle between an aeronautical chord of the blade and a tangent to the circular path circumscribed by the blade as it rotates around the central axis. The pitch angle is zero when the chord is tangential to the path of the blade. A positive pitch angle is measured when the leading edge of the blade is radially outboard of the trailing edge of the blade, and a negative pitch angle is measured when the leading edge is radially inboard of the trailing edge. Due to the reciprocating motion produced by the mechanism, the pitch angle of the blade is varied in a sinusoidal manner between a maximum pitch angle and a minimum pitch angle once every full rotation about the central axis. The maximum pitch angle may be a positive pitch angle, and the minimum pitch angle may be a negative pitch angle. The variation between the maximum pitch angle and the minimum pitch angle is referred to as the amplitude of the pitch angle.

It will be appreciated that the mechanism may be substantially any mechanism which is configured to produce reciprocating motion. Accordingly, the mechanism by comprise mechanical, electrical or hydraulic elements including motors, pumps or the like.

It will be appreciated that by pivotally mounted it is meant that the blade can rotate relative to the hub about an axis which is not the central axis. The blade may be pivotally mounted to the hub either directly or indirectly, such as for example via a strut or the like.

Although the first aspect of the invention relates to a vertical axis wind turbine, it will be appreciated that the term vertical axis is not intended as limiting upon the orientation of the wind turbine with respect to gravity. Rather, the term vertical axis wind turbine is intended to mean any wind turbine in which a work-producing portion of the blade, or blades, extends generally parallel to the central axis of the hub. As such, a vertical axis wind turbine could be positioned such that its central axis extends horizontally. Nonetheless, the central axis of the wind turbine of the first aspect of the invention may be oriented such that it is substantially vertical. It will be appreciated that the blades may be, for example, straight, helical, bow-shaped or the like.

The mechanism may comprise a stator portion inclinable relative to the central axis so as to define a tilt angle therebetween. By inclinable relative to the central axis it is meant that the stator portion is rotatable about an axis perpendicular to the central axis, for example a horizontal axis. When the stator portion is inclined relative to the central axis, this introduces an element of eccentricity into the mechanism which may be employed to produce a reciprocating motion. For example, a portion of the mechanism may be configured to rotate with the blade and hub about the central axis relative to the stator portion. The incline of the stator plate may therefore cause the portion of the mechanism to rise and fall along the central axis in response to rotation of the blade and hub so as to produce the reciprocating motion.

Because the stator portion is inclinable, it will be appreciated that reciprocating motion arising from the mechanism will be sinusoidal in nature. Furthermore, the reciprocating motion is defined by the movement of the blade about the central axis, and therefore the reciprocating motion is at the same frequency as the rotation of the blade. As such, the pitch angle of the blade can be continuously adjusted synchronously with the rotation of the blade about the central axis.

It will be appreciated that by tilt angle it is meant the angle between the stator portion and an axis generally orthogonal to the central axis and the axis of rotation of the stator portion. The tilt angle may be positive or negative, and is said to be zero when the stator portion is aligned such that a longitudinal axis of the stator portion is parallel to the central axis.

The mechanism may further comprise a rotor portion supported for rotation by and relative to the stator portion, wherein the rotor portion is configured to rotate with the blade about the central axis. The rotor portion may be supported by the hub such that the blade, hub and rotor portion are configured to rotate synchronously about the central axis. The rotation of the blade about the central axis therefore provides a driving force to produce the reciprocating motion. For example, when the stator portion is inclined relative to the central axis, this may produce a corresponding incline of the rotor portion. During use, for every full rotation of the rotor portion about the central axis, a point on the rotor portion will oscillate from a maximum elevation to a minimum elevation and back again. The linkage may be connected to the rotor portion so as to convert the motion of the point into reciprocating motion, which is transferred to the blade via the linkage.

The rotor portion may be supported by the stator portion such that the rotor portion is configured to tilt with the stator portion about the axis generally orthogonal to the central axis. For example, the mechanism may comprise a bearing arrangement configured to permit relative rotation between the rotor portion and the stator portion which simultaneously prevents separation of the rotor portion from the stator portion. The rotor portion and/or the stator portion may be aligned with the central axis.

The stator portion may be configured to receive a rotational input independent of the motion of the blade. That is to say, the stator portion can be rotated about the central axis independently of the blade and/or hub. The angular position of the blade relative to the stator portion about the central axis may define an azimuth angle of the blade. It will be appreciated that due to the action of the mechanism, the pitch angle of the blade may be varied as a function of the azimuth angle. Therefore, the maximum and minimum pitch angles may be configured to occur at the same azimuth angles for each rotation of the blade about the central axis. However, it will be appreciated that rotation of the stator portion relative to the central axis will rotate the frame of reference which determines the azimuth angle relative to the surrounding environment. As such, rotation of the stator portion may be used to change the angular positions at which the maximum and minimum pitch angles occur relative to the oncoming wind.

Preferably, the maximum pitch angle of the blade should occur when the blade is furthest upstream relative to the wind, and the minimum pitch angle should occur when the blade is furthest downstream relative to the wind. When oriented in this manner, the drag produced by the blade as it travels directly towards or away from the wind is minimised, and the lift produced by the blade at the upstream and downstream positions is increased. By rotating the stator portion relative to the central axis, the angular positions relative to the surrounding environment at which maximum and minimum pitch angles occur may be adjusted so as to account for any changes in the direction of the oncoming wind.

The wind turbine may further comprise a wind vane supported for rotation relative to the hub, the wind vane being configured produce a rotational input for the stator portion aligned with the direction of an oncoming wind. As such, the wind vane is able to automatically orient the stator plate with respect to the direction of the wind.

The wind turbine may further comprise a shaft having the wind vane and the stator portion mounted thereupon. The shaft permits the angular position of the wind vane to be transferred directly to the stator portion. The stator portion may inclinable relative to the shaft about an axis which is generally perpendicular to both a longitudinal axis of the wind vane which lies parallel to the wind direction and the central axis (i.e. such that all three axes are mutually orthogonal).

The wind turbine may further comprise a governor configured to adjust the tilt angle of the stator portion. The magnitude of the reciprocating motion is dependent upon the tilt angle (i.e. the inclination of the stator portion relative to the central axis). By adjusting the tilt angle, the amount of lift produced by the blade (and therefore the efficiency of the wind turbine) can be controlled by the governor. This is advantageous as it permits the wind turbine to be tuned so as to exhibit different efficiencies at different wind speeds. For example, the wind turbine may operate at high efficiency during low wind speeds, and may operate at reduced efficiency for high wind speeds. This may include running the wind turbine in a reverse mode during high wind speed in which the pitch angle of the blade is adjusted to produce more drag than normal so as aerodynamically slow the motion of the blade. This has the effect that the wind turbine can be used across a wider range of wind speeds.

The governor may comprise an actuation portion configured to produce linear movement in response to radial movement of a flyweight relative to the central axis. During use, rotation of the blade about the central axis may cause a centrifugal force to be applied to the flyweight so as to cause the flyweight to move in response. The movement of the flyweight can therefore be used to control the tilt angle of the stator plate, via the action of the actuation portion. As such, the amplitude of the variation in pitch angle of the blade can be controlled based upon the speed of rotation of the blade about the central axis.

The governor may further comprise a biasing member configured to bias the flyweight to a radially innermost position. As such, the biasing member can be used to tune the amount of centrifugal force required to permit a given movement of the flyweight. It follows that the properties of the flyweight and biasing member can be selected so as to determine the range of wind speeds over which the amplitude of the pitch angle is adjusted.

The radially innermost position of the flyweight may correspond to a maximum tilt angle of the stator portion. The tilt angle of the stator portion is therefore at a maximum value for low wind speed operation. As such, the amplitude of the variation of the pitch angle of the blade and therefore the lift produced by the blade is greatest during low wind speeds. Thus, the turbine may be able to self-start without requiring a starter motor.

Radial movement of the flyweight away from the central axis may cause the tilt angle of the stator portion to decrease. As such, the amplitude of the variation in the pitch angle decreases as the speed of rotation of the hub, and hence the centrifugal force on the fly-weights, increases. If the variation of the pitch angle is not reduced as the rotational speed of the hub increases, the blade and hub may rotate to unsafe operational speeds. In such conditions, centrifugal stresses due to the speed of rotation may cause mechanical failure of the components of the wind turbine.

The tilt angle may be reduced such that it is less than zero. When the tilt angle is less than zero, a large amount of drag may be produced by the blade so as to cause the rotation of the blade about the central axis to decelerate. That is to say, the pitch angle of the blade can be used to apply aerodynamic braking to prevent the rotational speed of the blade relative to the central axis becoming unsafe.

The governor may comprise two flyweights disposed opposite one another either side of the central axis. As such, the flyweights are balanced during rotation of the blade about the central axis to prevent mechanical resonance. In alternative embodiments, it will be appreciated that substantially any suitable number of flyweights may be used. The flyweights may be equi-spaced about the central axis so as to ensure they are rotationally (i.e. dynamically) balanced.

The blade may comprise an aerofoil. It will be appreciated that the aerofoil may be substantially any suitable shape, and may be symmetrical or asymmetrical. A longitudinal axis of the blade may extend generally parallel to the central axis.

The hub may comprise a radially extending strut, and wherein the blade is mounted to the strut such that the blade is spaced from the central axis. Because the blade is spaced from the central axis, the blade will produce more torque and therefore more power.

The turbine may further comprise a generator, or other suitable rotational power convertor, configured to convert rotational energy of the hub into useful work and/or electrical power. The blade may be one of a plurality of blades pivotally mounted to the hub and each defining pitch angle which is variable due to the action of the mechanism.

According to a second aspect of the present invention there is provided a method of operating a wind turbine according to the first aspect of the invention, wherein the method comprises varying the pitch angle from a maximum pitch angle to a minimum pitch angle during one half-rotation of the blade about the central axis, and from a minimum pitch angle to a maximum pitch angle during the other half-rotation of the blade about the central axis.

The method may further comprise adjusting the rotational position of the maximum and minimum pitch angles relative to the central axis in response to a wind direction.

The method may further comprise adjusting the amplitude of the variation in pitch angle in response to the speed of rotation of the hub.

It will be appreciated that any of the above-described optional features of the first and/or second aspect of the invention may be combined with substantially any of the other optional features of the first and/or second aspect of the invention as would be apparent to the skilled person.

Embodiments of the invention will now be described, by way of example only, with reference to the accompanying schematic drawings, in which:

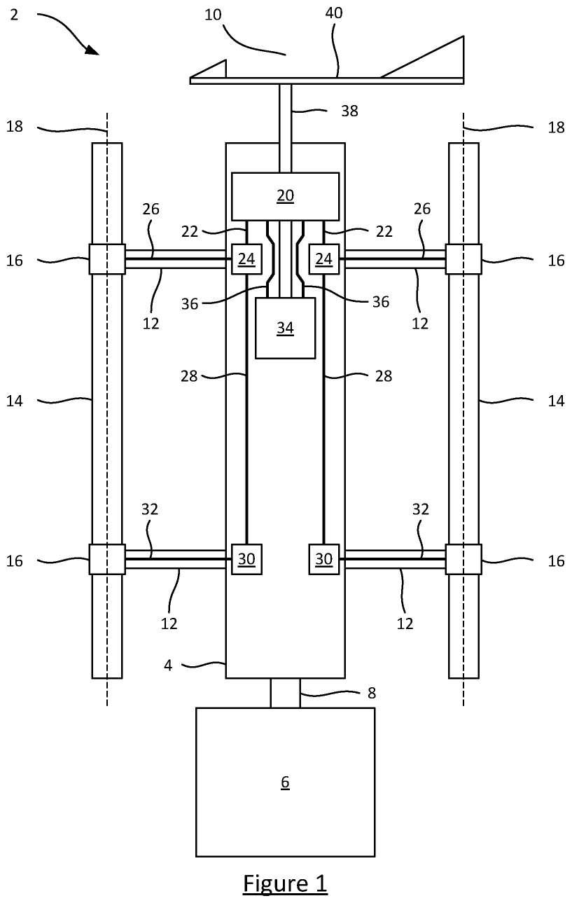

FIG. 1 is a schematic view of a vertical axis wind turbine according to the present invention;

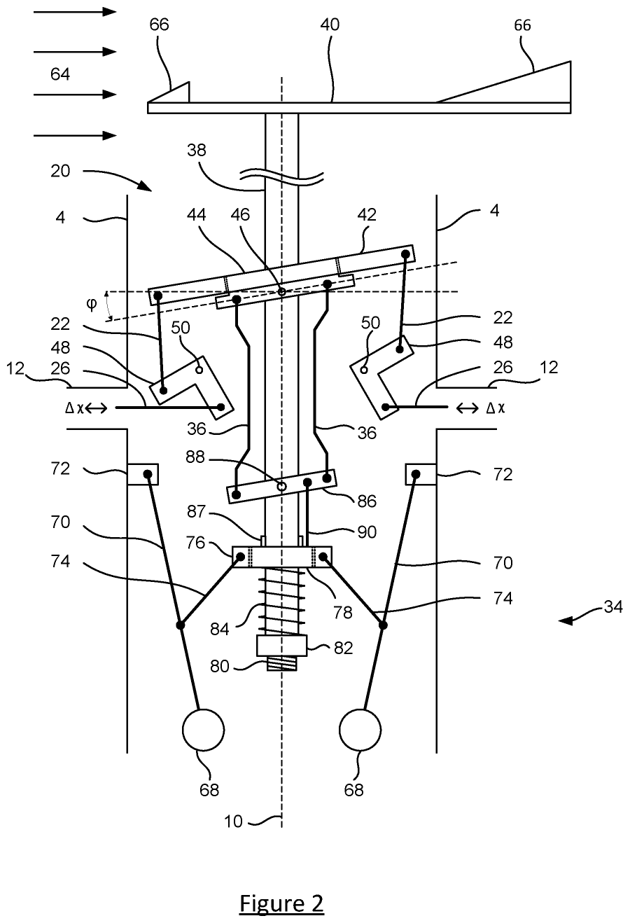

FIG. 2 is a schematic side view of a portion of a hub of the wind turbine of FIG. 1;

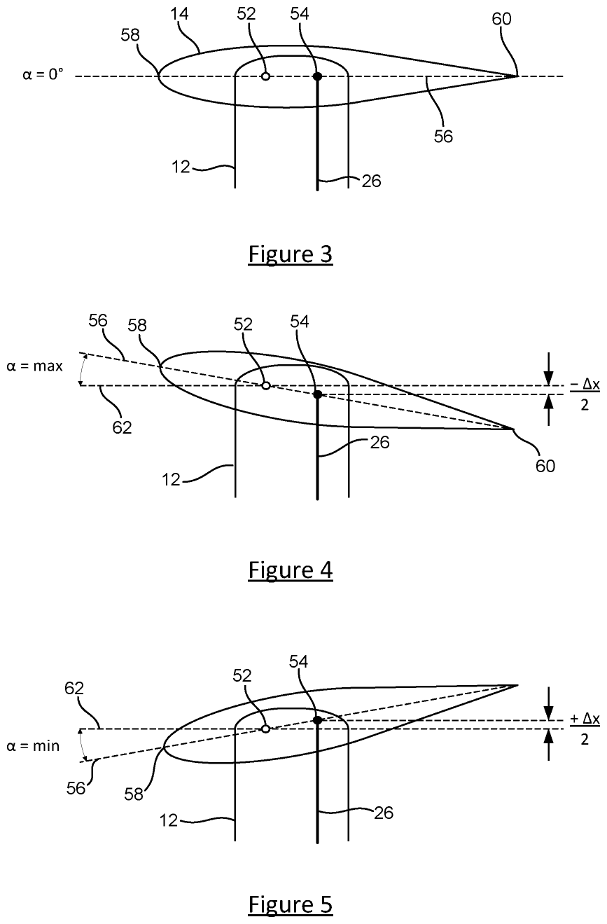

FIG. 3 is a schematic top view of a blade of the wind turbine at zero pitch angle;

FIG. 4 is a schematic top view of the blade of the wind turbine at a positive pitch angle;

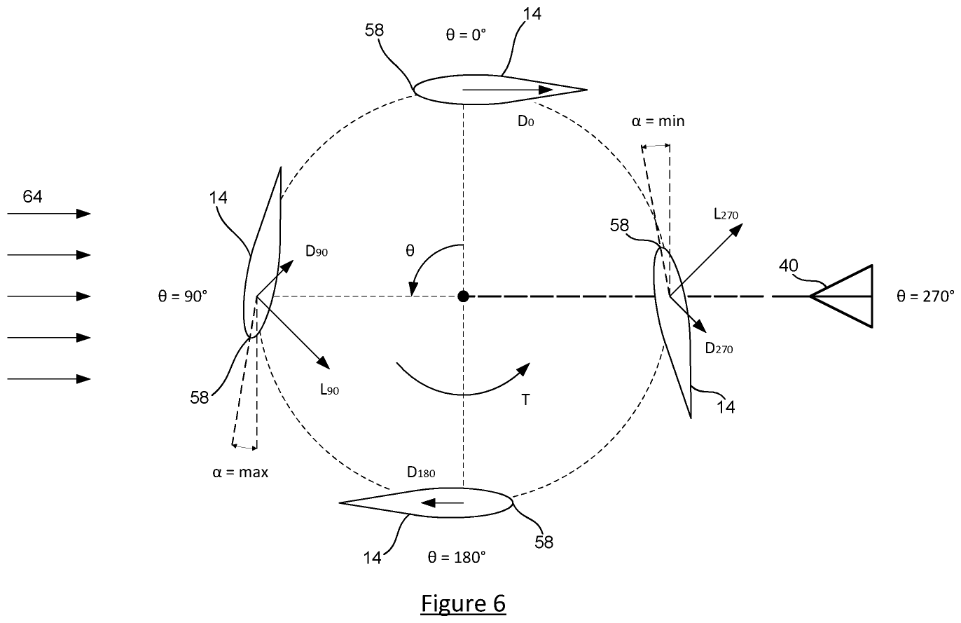

FIG. 5 is a schematic top view of the blade of the wind turbine at a negative pitch angle; and

FIG. 6 is a schematic top view showing the variation of a pitch angle of a blade in comparison it an azimuth angle of the blade; and

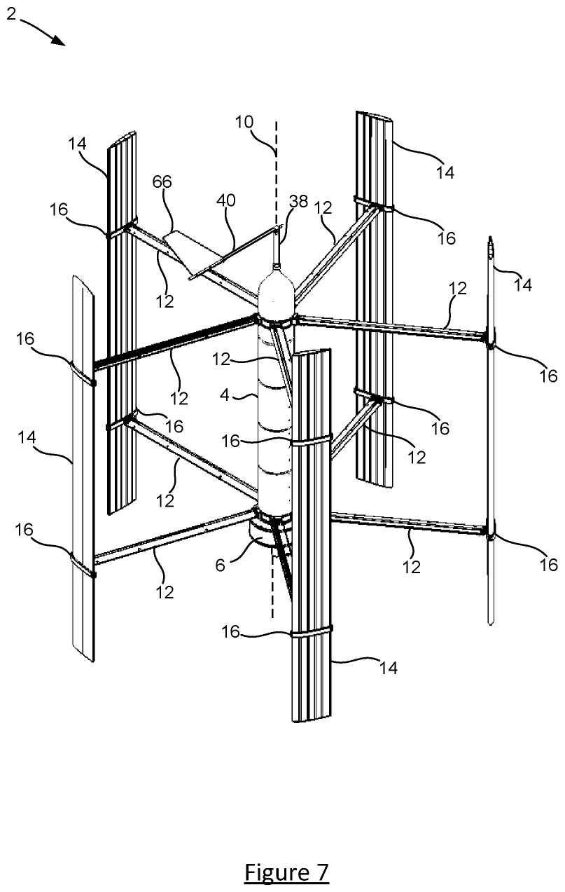

FIG. 7 is an isometric view of a vertical axis wind turbine according to the present invention.

FIG. 1 shows a schematic view of a variable-pitch vertical axis wind turbine 2 according to the present invention. The wind turbine 2 comprises a hub 4 mounted to a base 6 via a shaft 8 which are arranged such that the longitudinal centrelines of the hub 4, base 6, and shaft 8 are aligned along a common central axis 10. The hub 4 is generally tubular and defines a hollow interior, although it will be appreciated that the hub 4 make take any suitable construction as would be apparent to the skilled person. The hub 4 and shaft 8 are rotationally fixed to one another and are configured to co-rotate about the central axis 10 relative to the base 6 which is fixed to the ground. The hub 4 comprises two pairs of radially extending struts 12 positioned on diametrically opposite sides of the hub 4. Two blades 14 are mounted to the struts 12 via collars 16 such that each pair of struts 12 holds a single blade 14 therebetween. Each blade 14 defines a blade axis 18 and is oriented so that each blade axis 18 is generally parallel to the central axis 10. The collars 16 are configured to permit pivotal movement of the blades 14 relative to the struts 12 about the blade axes 18.

The hub 4 comprises swash mechanism 20 configured to output reciprocating motion to a pair of upper vertical linkages 22. The upper vertical linkages 22 are connected to a pair of upper rocking mechanisms 24 which are configured to transfer the reciprocating motion to a pair of upper horizontal linkages 26 and a pair of lower vertical linkages 28 simultaneously. The lower vertical linkages 28 are connected to a pair of lower rocking mechanisms 30 which are configured to transfer the reciprocating motion to a pair of lower horizontal linkages 32. The upper horizontal linkages 26 and lower horizontal linkages 32 extend through the struts 12, and are connected to the blades 14 via the collars 16 so as to convert the generally vertical motion of the vertical linkages 22, 28 into pivoting of the blades 14 about the blade axes 18.

The wind turbine 2 further comprises a governor 34 which is configured to control the amplitude of the reciprocating motion produced by the swash mechanism 20. The governor 34 is connected to the swash mechanism 20 via a pair of governor linkages 36. The governor 34 is located within the hub 4, however in alternative embodiments of the invention the governor 34 may be located external to the hub 4. The governor 34 and swash mechanism 20 are supported by a shaft 38 extending therethrough. The shaft 38 is supported for rotation relative to the hub 4 and relative to the base 6. A wind vane 40 is mounted to the shaft 38 above the hub 4, and is configured to rotate the swash mechanism 20 and governor 34 such that they are aligned with the direction of wind passing through the wind turbine 2.

During use, the blades 14 are blown by wind passing through the wind turbine 2 which causes the blades 14 to rotate about the central axis 10. The rotational movement of the blades 14 is transferred to the hub 4 via the collars 16 and struts 12 so as to cause the hub 4 to rotate about the central axis 10. The rotational movement of the hub 4 is transferred to the base 6 via the shaft 8. In some embodiments, the base 6 comprises an electricity generator (not shown) which is powered by the rotational movement of the shaft 8. In such embodiments, a transmission (not shown) may be provided to adjust (i.e. step up) the speed of the rotational input by the shaft 8 so that it is appropriate for electricity generation. The electricity generated by the electricity generator is output as electrical power which can be used to power electrical devices not forming part of the wind turbine 2.

With reference to FIG. 2, the swash mechanism 20 will now be described. The swash mechanism 20 comprises a generally annular rotor plate 42 and a generally annular stator plate 44. The stator plate 44 comprises a radially extending flange which supports the rotor plate 42 thereupon such that the stator plate 44 and rotor plate 42 are rotationally independent of one another. Although not shown, a bearing arrangement may be provided between the rotor plate 42 and stator plate 44 so as to aid relative rotation therebetween. The stator plate 44 is pivotally connected to the shaft 38 via a pin 46 so as to permit tilting of the rotor plate 42 and stator plate 44 within the plane of FIG. 2, whilst simultaneously fixing the rotational orientation between the stator plate 44 and the shaft 38 about the central axis 10. That is to say, the axis about which the rotor plate 42 and stator plate 44 may tilt is perpendicular to the plane of FIG. 2. In the position shown in FIG. 2, the rotor plate 42 and stator plate 44 are tilted at a tilt angle relative to the horizontal (i.e. an angle of 90°+relative to the central axis 10).

The upper vertical linkages 22 are connected to the rotor plate 42 by their terminal ends such that pivoting of the upper vertical linkages 22 in the plane of FIG. 2 is permitted, whilst the angular orientation between the upper vertical linkages 22 and the rotor plate 42 about the central axis 10 is fixed. The upper vertical linkages 22 are joined to the rotor plate 42 via their terminal ends at or near to the circumference of the rotor plate 42, such that they are radially spaced from the central axis 10 by an equal amount. The upper rocking mechanisms 24 are positioned below the rotor plate 42, each of which comprises a generally L-shaped rocking member 48. The upper vertical linkages 22 are connected to the rocking members 48 such that pivoting of the upper vertical linkages 22 relative to the rocking members 48 in the plane of FIG. 2 is permitted whilst the angular orientation between the upper vertical linkages 22 and the rocking members 48 about the central axis 10 is fixed. That is to say, the axis about which the rocking members 48 may pivot is perpendicular to the plane of FIG. 2. The rocking members 48 are pivotally mounted to the hub 4 via pins 50 positioned at the elbow of the rocking members 48. The pins 50 fix the angular orientation of the rocking members 48 relative to the hub 4 about the central axis 10. The upper horizontal linkages 26 are pivotally connected to the opposite ends of the rocking members 48 and extend radially away from the central axis 10 and into the struts 12. As such, the hub 4, rocking members 48, upper vertical linkages 22, upper horizontal linkages 26 and rotor plate 42 are configured to rotate together about the central axis 10 relative to the stator plate 44 and the shaft 38. Although not shown, in addition the rotor plate 42 may be provided with a radially extending strut configured to contact a portion of the hub 4 so as to transfer rotational movement of the hub 4 directly to the rotor 42.

During use, the hub 4 rotates about the central axis 10 due to the energy imparted upon the blades 14 by the wind. The rotational movement of the hub 4 is transferred to the rotor plate 42 via the pins 50, rocking members 48 and upper vertical linkages 22. However, because the rotor plate 42 is tilted relative to the horizontal by the stator plate 44, the upper vertical linkages 22 are moved up-and-down as they rotate about the shaft 38. For example, the upper vertical linkage 22 shown on the left hand side of FIG. 2 is at its lowest elevation, whilst the upper vertical linkage 22 shown on the right hand side of FIG. 2 is at its highest elevation. As such, the upper vertical linkages 22 perform one complete reciprocation for every 360° of rotation about the shaft 38. As such, the reciprocating motion produced by the swash mechanism 20 is sinusoidal in nature. This reciprocating motion is transferred to the upper horizontal linkages 26 via the rocking members 48 by pivotal movement of the rocking members 48 about the pins 50. As such, the upper horizontal linkages 26 are caused to reciprocate radially inwards and outwards. The amplitude of the reciprocating motion of the upper horizontal linkages 26 is defined as the distance x.

It will be appreciated that the embodiment of the swash mechanism 20 shown in FIG. 2 has been simplified for clarity. As such, although not shown in FIG. 2, it will be appreciated that the upper rocking mechanisms 24 may comprise additional features to transfer the reciprocating motion produced by the swash mechanism 20 to the lower vertical linkages 28, the lower rocking mechanisms 30 and the lower horizontal linkages 32. For example, the rocking members 48 may be generally T-shaped (rather than L-shaped, as shown) and the lower vertical linkages 28 may be connected to the rocking members 48 opposite the pins 50. As such, up-and-down reciprocating motion of the swash mechanism 20 can be transferred to the lower horizontal linkages via the lower vertical linkages 28 and the lower rocking mechanisms 30. The lower rocking mechanisms 30 may have a substantially similar structure to that described above in relation to the upper rocking mechanisms 24. Likewise, it will be appreciated that the upper rocking mechanisms 24 and lower rocking mechanisms 30 need not comprise L-shaped and/or T-shaped rocking members, but may comprise substantially any mechanism which is configured to transfer vertical reciprocating motion from the swash mechanism 20 to horizontal reciprocating motion of the upper horizontal linkages 26 and lower horizontal linkages 32. Furthermore, it will be appreciated that the lower rocking mechanisms 30 may comprise pins which act to transfer rotational movement of the hub 4 to the rotor plate 42 via the lower vertical linkages 28, the upper rocking mechanisms 24 and the upper vertical linkages 22.

FIG. 3 shows a cross-sectional view of a blade 14 of the wind turbine 2 mounted to a strut 12. The blade 14 defines a cross-section which is shaped so as to form an aerofoil. The blade is pivotally mounted to the strut 12 via a pin 52 which defines the blade axis 18. The blade axis 18 extends perpendicular to the strut 12 out of the plane of FIG. 3. The upper horizontal linkage 26 is pivotally connected to the blade 14 via a pin 54. The blade 14 defines an aeronautical chord 56 which runs from the centre of a leading edge 58 of the blade 14 to a trailing edge 60. It will be appreciated that substantially any aerofoil shape could be used as would be considered suitable by the person skilled in the art. In addition to the blades 14, the struts 12 may also be aerofoil-shaped.

Because the strut 12 extends generally radially from the hub 4, it will be appreciated that in the position shown in FIG. 3, the chord 56 is oriented generally tangentially to the path circumscribed by the blade 14 as it rotates about the central axis 10. The angle between the chord 56 and the tangent of the path circumscribed by the blade 14 as it rotates about the central axis 10 is referred to as the pitch angle, denoted by the letter. In FIG. 3, the pitch angle is zero (i.e. =0°) and the pin 54 which connects the upper horizontal linkage 26 to the blade 14 lies on the tangent to the path circumscribed by the blade 14.

FIG. 4 shows a cross-sectional view of the blade 14 in which the upper horizontal linkage 26 has been retracted from the position shown in FIG. 3 by half of the distance x (i.e. x/2). Because the pin 54 which connects the upper horizontal linkage 26 to the blade 14 is spaced apart from the pin 52 which defines the blade axis 18, when the upper horizontal linkage 26 is retracted the blade 14 pivots about the blade axis 18 relative to the strut 12. In particular, retraction of the upper horizontal linkage 26 causes the leading edge 58 to move radially outwards relative to the central axis 10. This results in a positive pitch angle between the chord 56 and a tangent 62 of the path circumscribed by the blade 14 (i.e. >0°).

FIG. 5 shows a cross-sectional view of the blade 14 in which the upper horizontal linkage 26 has been extended by half of the distance x (i.e. +x/2). As such, this causes the leading edge 58 to move radially inwards relative to the central axis 10. This results in a negative pitch angle between the chord 56 and the tangent 62 of the path circumscribed by the blade 14 (i.e. <0°).

Although FIGS. 4 to 6 are described with reference to one of the upper horizontal linkages 26, it will be appreciated that the same principals apply mutatis mutandis to the connection between the blades 14 and the lower horizontal linkages 32.

The operation of the wind turbine 2 at low wind speeds will now be described. FIG. 6 shows a schematic top view of the pitch angle of a blade 14 as it rotates about the central axis 10 relative to an oncoming wind 64. An azimuth angle of the blade 14 about the central axis 10 in the plane of FIG. 3 (i.e. the plane perpendicular to the central axis 10) is denoted by the symbol. The azimuth angle is said to be zero when the leading edge 58 of the blade 14 faces directly into the wind 64 (i.e. =0°) and increases in the direction of travel of the blade 14, which in FIG. 3 is the anti-clockwise direction. When the azimuth angle is zero, the pitch angle of the blade 14 is also zero. This corresponds to a position of the rotor plate 42 in which the two upper vertical linkages 22 are at the same elevation. When the leading edge 58 the blade 14 faces directly into the wind no lift is produced by the blade 14. However, depending upon the rotational velocity of the blade 14 about the central axis 10 (i.e. d/dt), the blade 14 will still produce a drag force D₀ which acts against the direction of travel of the blade 14.

Between =0° and =90°, as the azimuth angle increases so does the pitch angle by the action of the swash mechanism 20 as described above. When the azimuth angle is equal to 90°, the horizontal linkages 26, 32 are retracted by the distance x/2 such that the pitch angle is at a maximum. This corresponds to a position of the rotor plate 42 in which the upper vertical linkage 22 driving the blade 14 is at its minimum elevation, such as that shown on the left hand side of FIG. 2. Because the blade 14 is rotating about the central axis 10 at the same time as the wind 64 is travelling through the turbine 2, viewed from the perspective of the blade 14 the relative direction of the wind 64 to the blade 14 (also referred to as the angle of attack) is such that a lift force L₉₀ will be generated on the opposite side of the blade 14 from the direction of the oncoming wind 64. However, because the pitch angle of the blade 14 is at a maximum, the amount of lift L₉₀ produced by the blade 14 is increased relative to the situation where the pitch angle is equal to zero. The lift force L₉₀ produced by the blade 14 points slightly away from the central axis 10 in the anti-clockwise direction. The blade 14 will also produce a drag force D₉₀ which acts perpendicular to the lift force L₉₀. However, the magnitude of the drag force D₉₀ is outweighed by the magnitude of the lift force L₉₀. As such, a torque T is produced about the central axis 10 which drives further rotation of the blade 14 about the central axis 10. It will be appreciated that the amount of torque T produced by the blade 14 about the central axis 10 is equal to the sum of the components of the lift force L₉₀ and drag force D₉₀ which act tangentially to the azimuth direction multiplied by the radial distance of the centre of mass of the blade 14 relative to the central axis 10.

Between =90° and =180°, as the azimuth angle increases, the pitch angle also decreases by the action of the swash mechanism 20 as described above. When the azimuth angle is equal to 180°, the horizontal linkages 26, 32 return to the position shown in FIG. 3, such that the pitch angle is zero. This corresponds to a position of the rotor plate 42 in which the two upper vertical linkages 22 are at the same elevation. Because the pitch angle is zero, the leading edge 58 of the blade 14 faces directly away from wind 64 and therefore the blade 14 produces no lift. Depending upon the rotational velocity of the blade 14 about the central axis 10 (i.e. d/dt), the blade 14 will still result in the application of a drag force D₁₈₀ which resists motion of the blade 14 in the azimuth direction. However, because the oncoming wind 64 is blowing in the same direction as direction of travel of the blade 14, the magnitude of the drag force D₁₈₀ is less than the magnitude of the drag force D₀ when the azimuth angle is zero.

Between =180° and =270°, as the azimuth angle increases so does the pitch angle by the action of the swash mechanism 20 as described above. When the azimuth angle is equal to 270°, the horizontal linkages 26, 32 are extended by the distance x/2 such that the pitch angle is at a minimum. This corresponds to a position of the rotor plate 42 in which the two upper vertical linkages 22 are at their maximum elevations (such as that shown in FIG. 2) Because the blade 14 is rotating about the central axis 10 at the same time as the wind 64 is travelling through the turbine 2, viewed from the perspective of the blade 14 the angle of attack is such that a lift force L₂₇₀ will be generated on the opposite side of the blade 14 from the direction of the oncoming wind 64. However, because the pitch angle of the blade 14 is at a minimum, the amount of lift L₂₇₀ produced by the blade 14 is increased relative to the situation where the pitch angle is equal to zero. The lift force L₂₇₀ produced by the blade 14 points away from the central axis 10 in the anti-clockwise direction. The blade 14 also produces a drag force D₂₇₀ which acts perpendicular to the lift force L₂₇₀. However, as for when=90°, the magnitude of the drag force D₂₇₀ is outweighed by the magnitude of the lift force L₂₇₀. Again, a torque T is produced about the central axis 10 which drives further rotation of the blade 14 about the central axis 10. It will be appreciated that the amount of torque T produced by the blade 14 about the central axis 10 is equal to the sum of the components of the lift force L₂₇₀ and drag force D₂₇₀ which act tangentially to the azimuth direction multiplied by the radial distance of the centre of mass of the blade 14 relative to the central axis 10.

Between =270° and =360°, as the azimuth angle increases, the pitch angle also increases by the action of the swash mechanism 20 as described above. Once the azimuth angle reaches 360° the rotational cycle about the central axis 10 is complete and starts again as described above when the azimuth angle is zero.

Because the pitch angle varies between a maximum and a minimum value when the blade 14 travels between an upwind and a downwind position, the amount of lift generated by the blades 14 is increased. This enables the wind turbine 2 to begin rotating at relatively low wind speeds compared to previously known wind turbines. As such, the wind turbine 2 can begin producing power at wind speeds which would not otherwise be sufficient to cause rotation of the blades 14. In some embodiments, the variation of the pitch angle 14 may even be sufficient to permit the wind turbine 2 to self-start (that is, to begin rotating without any other mechanical inputs such as a starter motor).

With reference to FIG. 2, the wind vane 40 is connected to the shaft 38 such that it extends horizontally within the plane of FIG. 2 and generally perpendicular to the pin 46 which connects the stator plate 44 to the shaft 38. The wind vane 40 is mounted asymmetrically relative to the central axis 10 and comprises one or more fins 66 configured to cause drag in the wind 64. When the wind 64 acts on the wind vane 40, the drag produced on the fins 66 causes the wind vane 40 to rotate about the central axis 10, and hence also cause rotation of the swash mechanism 20. Furthermore, because the wind vane 40 is mounted asymmetrically relative to the central axis 10 the wind vane 40 is configured to trail in the wind 64. Using the wind vane 40 to orientate the swash mechanism 20 relative to the direction of the wind ensures that, for low wind speeds, the maximum pitch angle occurs when the blade 14 is at its most upstream position relative to the oncoming wind 64. As such, the efficiency of the wind turbine 2 at low wind speeds is optimised.

It will be appreciated that the skilled person may select the magnitude of the maximum and minimum pitch angles of the blades 14 so as to suit a particular range of wind speeds. Typically the wind turbine 2 is configured so that the pitch angle may vary between ±30°. In some embodiments the pitch angle may be varied by greater amounts, for example ±35° or ±45°. Alternatively, the pitch angle may be varied by lesser amounts, for example ±5° or ±10°. Furthermore, the variation of pitch angle in the positive direction may have a different magnitude than the variation of pitch angle in the negative direction (i.e. such that the variation in pitch angle is unequal relative to the tangent of the path circumscribed by the blade 14).

It will be appreciated that as the speed of the wind 64 increases the torque T produced by the blades 14 about the central axis 10 increases proportionally. Furthermore, as the torque T about the central axis 10 increases, the speed of rotation of the blades 14 about the central axis 10 (i.e. d/dt) also increases. It will be appreciated that as the blades 14 rotate about the central axis 10, they will exert a centrifugal force acting radially outwards from the central axis 10. It follows that as the speed of rotation of the blades 14 relative to the central axis 10 increases, the centrifugal force produced by the blades also increases. Left uncontrolled, this centrifugal force may eventually become sufficient to cause the blades 14 to detach from the wind turbine 2, representing not only a catastrophic operational failure of the turbine 2, but also a significant safety risk.

With reference to FIG. 2, the operation of the governor 34 will now be described. The governor 34 comprises a pair of masses 68 disposed at the terminal ends of a pair of arms 70 which are pivotally mounted to the hub 4 via supports 72. A pair of yokes 74 extend between the arms 70 and an outer collar 76. The yokes 74 are pivotally connected at one end to the arms 70 at a position generally midway between the terminal ends of the arms 70, and pivotally connected by their opposite ends to the outer collar 76. The outer collar 76 is mounted to an inner collar 78 which supports the outer collar 76 for rotation relative to the shaft 38 by an inner collar 78. Because the supports 72 are mounted to the hub 4, the outer collar 76, yokes 74, supports 72, arms 70, and masses 68 are rotationally fixed relative to one another about the central axis 10 and rotate together with the blades 14 and hub 4.

The inner collar 78 and outer collar 76 configured to translate with one another along the shaft 38. The inner collar 78 is rotationally fixed relative to the shaft 38. Although not shown, a bearing assembly is disposed between the inner collar 78 and outer collar 76 so as to permit relative rotation therebetween. The shaft 38 comprises a threaded portion 80 at a terminal end, the threaded portion 80 having a nut 82 disposed thereupon. A spring 84 is positioned between the nut 82 and the inner collar 78 and acts to bias the inner collar 78 (and hence also the outer collar 76) vertically upwards in the direction away from the nut 84 along the central axis 10. The shaft 38 further comprises a stop 87 which is configured to limit the movement of the inner collar 78 in the vertical direction.

The governor 34 further comprises a tilt plate 86 which is pivotally connected to the shaft 38 via a pin 88. The pin 88 which connects the tilt plate 86 to the shaft 38 extends substantially parallel to the pin 46 which connects the stator plate 44 to the shaft 38, such that the tilt plate 86, stator plate 44 and rotor plate 42 all pivot in the same plane. The governor linkages 36 are pivotally connected to tilt plate 86 and the stator plate 44 such that the tilt plate 86, stator plate 44 and rotor plate 42 are always inclined at the same tilt angle relative to the central axis 10 (i.e. such that they are always parallel).

A vertical link member 90 is pivotally connected to the tilt plate 86 at one of its ends, and fixedly connected to the inner collar 78 at its opposite end. As such, movement of the inner and outer collars 76, 78 along the shaft 38 causes pivoting of the tilt plate 86 within the plane of FIG. 2. Pivoting of the tilt plate 86 is passed on to the stator plate 44 and rotor plate 42 via the governor linkages 36 and thus controls the tilt angle of the swash mechanism 20. As such, translation of the inner and outer collars 78, 76 along the shaft 38 controls the magnitude of the maximum and minimum pitch angles of the blades 14.

During use, wind energy imparted on the blades 14 causes the hub 4 to rotate about the central axis. Rotation of the hub 4 causes a centrifugal force to act upon the masses 68 in a radially outwards direction relative to the central axis 10. The centrifugal force is passed to the arms 70 which experience a torque about the supports 76. The torque pulls upon the yokes 74 causing the outer collar 76 to be urged vertically downwards against the action of the spring 84. At low wind speeds, the speed of rotation of the hub 4 is relatively low and therefore the centrifugal force experienced by the masses 68 is not sufficient to cause movement of the inner and outer collars 78, 76 along the shaft 38 against the action of the spring 84. As such, at low wind speeds the magnitude of the maximum and minimum pitch angles of the blades 14 is determined by the position of the stop 87, which acts to limit axial translation of the inner and outer collars 78, 76 along the shaft 38.

However, as the speed of rotation of the hub 4 increases, so too does the centrifugal force experienced by the masses 68. Eventually, the centrifugal force becomes sufficient to overcome the action of the spring 84, causing the masses 68 to move radially outwards relative to the central axis 10. Movement of the masses 68 causes the inner and outer collars 78, 76 to move axially downwards along the shaft 38 and compress the spring 84. This causes the tilt angle of the swash mechanism 20 to reduce, causing a corresponding reduction in the magnitude of the maximum and minimum pitch angles of the blades 14. By reducing the magnitude of the maximum and minimum pitch angles, the amount of lift produced by the blades 14 is also reduced, causing a drop in the efficiency of the wind turbine 2.

As the wind speed increases, the speed of rotation of the hub 4 causes the tilt angle to approach zero. When the tilt angle is equal to zero, the pitch angle of the blades 14 does not vary as the blades 14 rotate about the central axis 10. That is to say, the pitch angle is zero for all 360° of rotation about the central axis 10. This causes the blades 14 to produce less lift and thus the efficiency of the wind turbine 2 is reduced. As such, the speed of rotation of the hub 4 increases at a slower rate with increasing wind speed. That is to say, the rotational acceleration of the hub 4 reduces with increasing wind speed.

The tilt angle may decrease such that it is less than zero. In this configuration, the swash mechanism is inclined in the opposite direction as that shown in FIG. 2. As such, the minimum pitch angle occurs when the blades 14 are at their most upstream position relative to the wind 64 (=90°), and the maximum pitch angle occurs when the blades 14 are at their most downstream position relative to the wind 64 (=270°). That is to say, the variation of the pitch angle with the azimuth angle is inverted or reversed. This causes the drag produced by the blades 14 to increase greatly, and therefore the blades 14 exert a torque in the opposite direction to the direction of rotation of the blades 14 about the central axis 10. As such, the speed of rotation of the hub 4 is reduced.

Once the speed of rotation of the hub 4 has reduced, the centrifugal force exhibited by the masses 68 is also reduced. The spring 84 is therefore able to overcome the action of the centrifugal force and thereby move the inner and outer collars 78, 76 vertically upwards, resulting in a corresponding increase in the tilt angle of the swash mechanism 20. As such, the speed of the wind turbine 2 is entirely self-regulating. It follows that the properties of the governor 34 can be selected so as to maximise the range of wind speeds in which the wind turbine 2 may operate. For example, the skilled person may adjust the length of the arms 70, weight of the masses 68, the stiffness of the spring 84, position of the nut 82 or the like so as to determine the wind speed at which the tilt angle becomes zero.

Although the wind turbine 2 described above comprises a governor 34 to control the speed of rotation of the blades 14 about the central axis 10, it will be appreciated that in some embodiments the wind turbine 2 may alternatively or additionally comprise a brake unit configured to exert a braking force upon the hub 4 and/or shaft 8 to limit the speed of rotation.

Although the governor 34 described above comprises two sets of masses 68, arms 70, and yokes 74 arranged symmetrically about the central axis 10, it will be appreciated that in alternative embodiments of the invention the governor 34 may comprise three or more sets of masses 68, arms 70, and yokes 74 arranged symmetrically about the central axis 10.

FIG. 7 shows an exemplary embodiment of a vertical axis wind turbine 2 according to the present invention. The same reference numerals are used within FIG. 7 for features which correspond to those of FIGS. 1 to 6. The exemplary wind turbine 2 comprises a hub 4 mounted upon a base 6. Five pairs of aerofoil-shaped struts 12 extend horizontally outwards from the hub 4 and support five blades 14 thereupon. The blades 14 are supported by collars 16 formed at the ends of the struts 12. A shaft 38 extends from the top of the wind turbine 2 and supports a wind vane 40 thereupon. The hub 4 comprises an external casing configured to protect the internal components of the wind turbine 2 from the wind. As such, the internal components of the wind turbine 2 are not visible in FIG. 7. The internal components of the wind turbine 2 include the swash mechanism 20, governor 34 and the like. Although the internal components are not shown, it will be appreciated that the wind turbine 2 works in substantially the same manner as that set out above with respect to FIGS. 1 to 6.

Exemplary dimensions and operational parameters of the wind turbine 2 will now be given. The diameter of the hub 4 is approximately 0.3 m. The vertical height of the hub 4 and the blades 14 is approximately 3.5 m. The length of the aeronautical chord of the blades 14 is approximately 0.3 m. The width of the blades 14 is approximately 0.05 m. The radial spacing of the blades 14 from the central axis 10 is approximately 2.5 m. The length of the wind vane 40 is approximately 1.5 m. The pitch angle of the blades 14 is variable between a maximum of ±10° from the tangent of the path of the blades 14. Based upon these parameters, the wind turbine 2 is able to produce approximately 3 kW of power in wind speeds ranging from approximately 3 to 30 m·s⁻¹. Although example dimensions and parameters of the wind turbine 2 are given above, it will be appreciated that the wind turbine 2 can be configured to produce greater or lesser amounts of power by increasing or decreasing the dimensions accordingly. Other adjustments may be made to the operation of the wind turbine 2 to optimise the amount of power produced as would be apparent to the skilled person.

Although the exemplary embodiment comprises five blades 14, it will be appreciated that in alternative embodiments substantially any number of blades may be used. However, at least two blades 14 are preferable so as to balance the weight of the turbine 2 either side of the hub 4. It will be appreciated that maximum lift is produced by the blades 14 when=90° and 180°. As such, where the wind turbine 2 comprises only two blades 14 (or multiples thereof) the wind turbine 2 will produce electrical energy in a pulse-like manner, which may be undesirable. As such, most preferably, five blades 14 (or any odd number) are provided so as to reduce the effects of the incidence of pulsing during electricity generation, and mechanical resonance during rotation of the blades 14 about the central axis 10.

It will be appreciated that although the wind turbine 2 is described as a vertical axis wind turbine, the orientation of the turbine with respect to gravity is not intended as limiting on the invention. In particular, the central axis 10 of the wind turbine 2 could be oriented horizontally, or indeed at any angle with respect to gravity.

Although the foregoing description relates to a wind turbine 2, it will be appreciated that in alternative embodiments of the invention the turbine may be configured for use within substantially any fluid medium. For example, in an alternative embodiment, the turbine may be configured for use underwater. Such a turbine would be suitable for use in tidal and/or hydro power generation.

It will be appreciated that although the wind turbine 2 above is described as comprising only a single hub 4 having blades 14 mounted thereon, in alternative embodiments of the invention the wind turbine 2 may comprise a plurality of hubs 4 with separate sets of blades 14. The plurality of hubs 4 may be mounted to a common shaft such that the plurality of hubs 4 rotate in unison, or may be configured such that each hub 4 rotates independently. In tidal and/or hydro power applications, a string of hubs 4 may be provided which are oriented generally horizontally and submerged underwater.

1. A variable-pitch vertical axis wind turbine comprising:
a hub supported for rotation about a central axis;
a blade pivotally mounted to the hub so as to permit relative rotation between the blade and the hub, the blade and the hub defining a pitch angle therebetween;
a mechanism configured to produce reciprocating motion during rotation of the hub about the central axis; and
a linkage configured to transfer the reciprocating motion produced by the mechanism to the blade so as to vary the pitch angle.

2. A wind turbine according to claim 1, wherein the mechanism comprises a stator portion inclinable relative to the central axis so as to define a tilt angle therebetween.

3. A wind turbine according to claim 2, wherein the mechanism further comprises a rotor portion supported for rotation by and relative to the stator portion, wherein the rotor portion is configured to rotate with the blade about the central axis.

4. A wind turbine according to claim 2, wherein the stator portion is configured to receive a rotational input independent of the motion of the blade.

5. A wind turbine according to claim 4, further comprising a wind vane supported for rotation relative to the hub, the wind vane being configured produce a rotational input for the stator portion aligned with the direction of an oncoming wind.

6. A wind turbine according to claim 5, wherein the wind turbine further comprises a shaft having the wind vane and the stator portion mounted thereupon.

7. A wind turbine according to claim 2, wherein the wind turbine further comprises a governor configured to adjust the tilt angle of the stator portion.

8. A wind turbine according to claim 7, wherein the governor comprises an actuation portion configured to produce linear movement in response to radial movement of a flyweight relative to the central axis.

9. A wind turbine according to claim 8, wherein the governor further comprises a biasing member configured to bias the flyweight to a radially innermost position.

10. A wind turbine according to claim 9, wherein the radially innermost position of the flyweight corresponds to a maximum tilt angle of the stator portion.

11. A wind turbine according to claim 8, wherein radial movement of the flyweight away from the central axis causes the tilt angle of the stator portion to decrease.

12. A wind turbine according to claim 11, wherein the governor comprises two flyweights disposed opposite one another either side of the central axis.

13. A wind turbine according to claim 1, wherein the blade comprises an aerofoil.

14. A wind turbine according to claim 1, wherein a longitudinal axis of the blade extends generally parallel to the central axis.

15. A wind turbine according to claim 1, wherein the hub comprises a radially extending strut, and wherein the blade is mounted to the strut such that the blade is spaced from the central axis.

16. A wind turbine according to claim 1, wherein the turbine further comprises a generator connected configured to convert rotational energy of the hub into electrical power.

17. A wind turbine according to claim 3, wherein the blade is one of a plurality of blades pivotally mounted to the hub and each defining pitch angle which is variable due to the action of the mechanism.

18. A method of operating a wind turbine having a hub supported for rotation about a central axis, a blade pivotally mounted to the hub so as to permit relative rotation between the blade and the hub, the blade and the hub defining a pitch angle therebetween, a mechanism configured to produce reciprocating motion during rotation of the hub about the central axis, and a linkage configured to transfer the reciprocating motion produced by the mechanism to the blade so as to vary the pitch angle the method comprising varying the pitch angle from a maximum pitch angle to a minimum pitch angle during one half-rotation of the blade about the central axis, and from a minimum pitch angle to a maximum pitch angle during the other half-rotation of the blade about the central axis.

19. The method of claim 18, wherein the method further comprises adjusting the rotational position of the maximum and minimum pitch angles relative to the central axis in response to a wind direction.

20. The method of claim 18, wherein the method further comprises adjusting the amplitude of the variation in pitch angle in response to the speed of rotation of the hub.
